(19) United States
(12) Patent Application Publication
(10) Pub. No.: US 2004/0157758 A1
(43) Pub. Date: Aug. 12, 2004

(54) Method for cleaning and protecting siliceous surfaces using co-polymer compounds

(75) Inventors: C. Frederick Adickes, Tustin, CA (US); Bret W. Aiken, Costa Mesa, CA (US); James D. Aiken, Chino, CA (US)

Correspondence Address: STERNE, KESSLER, GOLDSTEIN & FOX PLLC, 1100 NEW YORK AVENUE, N.W., WASHINGTON, DC, 20005, US

(73) Assignee: CTEK Coatings, LLC

(21) Appl. No.: 10/359,721

(22) Filed: Feb. 7, 2003

(51) Int. Cl. B05D 1/36; C11D 7/02

(52) U.S. Cl. 510/180; 427/140; 510/511

(57) ABSTRACT

A method of protecting and maintaining a surface of a siliceous material includes restoring damaged portions of the surface of the siliceous material, cleaning the surface of the siliceous material, applying a reactive chemical solution to the surface of the siliceous material to cause a linking between carbon atoms in said reactive chemical solution to oxygen atoms in the siliceous material near the surface, thereby forming a continuous carbon chain to produce a hydrophobic surface having reduced surface tension, applying a protective coating to the hydrophobic surface to infill porosity of the hydrophobic surface to preclude contamination and to further decrease surface tension, and periodically cleaning the surface and re-applying said protective coating to maintain the surface.

### BACKGROUND OF THE INVENTION

1. Field of the Invention

The invention relates generally to water repellent coatings, and more particularly, to liquid systems and methods for providing protection against water damage and intrusion when applied to structural materials such as glass, wood, concrete, ceramic, tile, stone, stucco and composites used, for example, in the construction and automotive industries.

2. Related Art

Modern automobiles and buses require frequent attention to the windshield and windows to insure safe operation. The glass must be kept reasonably clean for visibility. It is desirable to seal the glass to enhance its water and contaminant repellant properties. However, conventional glass cleaner treatments fail to make the glass repel water and contaminants in outside environments for sufficiently long periods of time, and require constant replenishment. U.S. Pat. No. 3,940,588 teaches coating with hydrolyzable di-silyl poly(perflourooxyalkene) to produce oil and water repellent coatings. U.S. Pat. No. 4,410,563 covers water repellent coatings for optical surfaces including windshields based on Dow Corning 531 and 536 fluids, amino functional polydimethylsiloxane. Furthermore, the coatings have to be reapplied frequently to maintain the water repellent effect. Treatments to modify the glass and make it repel water have also been taught in U.S. Pat. No. 5,415,927, wherein organic silicon and fluorine compounds are used to form water repellent layers. These conventional windshield washer solvents fail to provide an automotive glass surface that repels water without extensive pretreatment or application surface preparation.

When a glass surface is provided with water repellency, a variety of effects can be expected. For example, (1) since waterdrops, which contain pollutants, hardly adhere to, or remain on, a glass surface, contamination and yellowing of the glass surface can be substantially prevented, and (2) when water-repellent glass is used as glass for a windshield or side window of an automobile or bus, water on the glass is blown off due to a wind pressure while the automobile or bus is moving in the rain, and the driver's visual field is improved. Water-repellent glass is generally produced by a wet-coating method in which a water-repellent agent containing an organic silicon compound, typified by a polydimethylsiloxane compound or a fluorine-containing silicon compound, is wet-coated on a glass surface, or by a dry-coating method in which the above water-repellent agent is dry-coated by means of plasma or vapor deposition. However, in the known methods of coating the water-repellent agent directly on a glass surface, it is difficult to maintain water repellency for a long time, since the adhesion strength between the water-repellent agent and the glass is low.

To a lesser extent, other materials, such as concrete compounds, granite, tile, metal surfaces and natural stone are also deteriorated by exposure to the elements. When water penetrates into a substrate and then freezes, the substrate cracks and offers more avenues for water intrusion. As the freeze/thaw cycle continues, the material continues to lose structural integrity.

While various protective products are commercially available which are indicated to have efficacy as water repellents, these products do not possess a sufficient effective usage period and require frequent re-application. The need still exists for a product and a method of application that maintains its water-repellent efficacy for longer periods of time.

### BRIEF SUMMARY OF THE INVENTION

Accordingly, the present invention is directed to a method for cleaning and protecting surfaces that substantially obviates, one or more of the disadvantages of the related art.

There is provided a method of protecting and maintaining a surface of a siliceous material including restoring damaged portions of the surface of the siliceous material, cleaning the surface of the siliceous material, applying a reactive chemical solution to the surface of the siliceous material to cause a linking between carbon atoms in the reactive chemical solution to oxygen atoms in the siliceous material near the surface, thereby forming a continuous carbon chain to produce a hydrophobic surface having reduced surface tension, applying a protective coating to the hydrophobic surface to infill porosity of the hydrophobic surface to preclude contamination and to further decrease surface tension, periodically cleaning the surface, and re-applying the protective coating to maintain the surface.

In another aspect, there is provided a method of protecting and maintaining a surface of a siliceous material including applying a reactive solution to a clean surface of the siliceous material to link carbon atoms in the reactive solution to oxygen atoms in the siliceous material near the surface, thereby forming a hydrophobic surface having reduced surface tension, applying a siliconized co-polymer protective coating to the hydrophobic surface to infill porosity of the hydrophobic surface to preclude contamination and to further decrease surface tension, periodically cleaning the surface and re-applying a mixture of the protective coating and alcohol to maintain hydrophobic properties of the surface.

In another aspect, there is provided a method of protecting and maintaining a surface of a siliceous materials including restoring damaged portions of the surface of the siliceous material, cleaning the surface of the siliceous material, sealing the surface of the siliceous material, applying a protective coating to the surface of the siliceous material, and periodically applying a rejuvenating cleaner to the surface of the siliceous material.

In another aspect, there is provided a method of protecting a surface including applying a reactive solution to the surface to link carbon atoms in the reactive solution to oxygen atoms near the surface, thereby forming a hydrophobic surface having reduced surface tension, and applying a siliconized co-polymer protective coating to the hydrophobic surface.

In another aspect, there is provided a method of protecting a surface including applying a reactive solution to the surface to link carbon atoms in the reactive solution to oxygen atoms near the surface, thereby forming a hydrophobic surface having reduced surface tension, and applying a regenerative solution of about 15-40% siliconized copolymer and 60-85% alcohol to the hydrophobic surface.

In another aspect, there is provided a method of protecting a surface including cleaning a surface of any corrosion and damage, the surface being selected from any one of porcelain, tile, marble, stone, travertine, metal, vinyl, paint, glass, etched glass or granite, and applying a siliconized co-polymer protective coating to the surface.

In another aspect, there is provided a method of protecting a surface including cleaning a surface of any corrosion and damage, applying a reactive solution to the surface to link carbon atoms in the reactive solution to oxygen atoms near the surface, thereby forming a hydrophobic surface having reduced surface tension, and wiping off excess reactive solution from the surface with a micro-fiber cloth.

Additional features and advantages of the invention will be set forth in the description that follows, and in part will be apparent from the description, or may be learned by practice of the invention. The advantages of the invention will be realized and attained by the structure particularly pointed out in the written description and claims hereof.

It is to be understood that both the foregoing general description and the following detailed description are exemplary and explanatory and are intended to provide further explanation of the invention as claimed.

### DETAILED DESCRIPTION OF THE INVENTION

Reference will now be made in detail to the preferred embodiments of the present invention.

Surface Preparation

As a preliminary step, prior to application of protective coatings, glass, stone, vinyl, paint, metal, granite, porcelain and tile surfaces should be prepared by cleaning them, drying them, and freeing them from stains and contaminants. In other words, to the extent possible, a “virgin” surface should be prepared.

To remove damage and clean hard-to-reach areas, such as corners and against window frames, window acid cleaner (e.g, a commercially available window acid cleaner, such as Winsol Crystal Clear 550, available from Winsol Laboratories, 1417 N.W. 51^{st} Street, Seattle, Wash. 98107) may be used.

A small amount of the window acid cleaner should be applied on a PVA (polyvinylalcohol) sponge, without over-saturating and allowing the window acid cleaner to drip onto other surfaces. If this occurs, the surface should be immediately flushed with water. PVA sponges are available, for example, from Sponge King Corporation, Ltd. of Hong Kong, China (703, 7/F., Chevalier Commercial Centre, 8 Wang Hoi Road, Kowloon Bay, Kowloon, Hong Kong).

The window acid cleaner should be rubbed over the area until the entire area has a consistent wetted sheen, then flushed with clean water, and dried and inspected for missed corrosion damage. The process should be repeated if needed to remove all corrosion damage.

Note that it is preferable to not over-saturate the surface with water, and not to allow the window acid cleaner to drip on to other surfaces to which treatment is generally not being applied. If the window acid cleaner is applied to other surfaces by mistake, those surfaces should be immediately flushed with water.

Stage I corrosion is light spotting appearing on the glass after cleaning the surface with a soft cloth and denatured alcohol. The glass is relatively clear and free of etched memory paths that look like dried riverbeds. Stage I corrosion can be removed by a glass restoration paste (discussed below).

Stage II corrosion is when glass surface deposits have penetrated the immediate surface layer, and have started to break-down (corrode) the internal molecular structure within the glass, creating an etched or white glaze after the surface deposit and stain have been removed, or if spotting appears to have penetrated the surface indicted by a white haze or deep etch in the glass. A water spot remover (discussed below) may be used to remove Stage II corrosion.

Glass Restoration Paste

A non-abrasive (or mildly abrasive) glass restoration paste may be used to polish minor scratches and corrosion out of glass, restoring glass to its natural, clear state. The glass restoration paste is designed to polish minor scratches and Stage I or II corrosion out of glass, preferably using a rotor tool, to return the glass to its natural, clear state. In the preferred embodiment the glass restoration paste includes about 60% 700 Grit pumice (SiO₂) and about 40% Cerium Oxide. Alternatively, the glass restoration paste may include about 60% 700 Grit pumice, 16 to 28% Cerium Oxide and 16 to 28% Lanthanum Oxide.

Glass surface should be prepared by first cleaning surface stains with a soft cotton cloth (or a soft brush) and denatured alcohol. To restore Stage II corrosion, a water spot remover, described below, can also be used, as described below. For Stage I corrosion, a generous amount of glass restoration paste should be applied on an absorbent cloth and aggressively rubbed into the surface of the glass. The glass surface should be rinsed with water, and inspected for missed corrosion damage. The process should be repeated, if needed, to remove all corrosion damage. If spots are still present after two applications, the following steps for Stage II corrosion should preferably be followed.

Following surface cleaning with denatured alcohol and/or window acid cleaner, the glass restoration paste is preferably applied as follows:

The glass restoration paste should preferably be applied using the rotor tool with an abrasive application pad, and clean water in a spray bottle. The rotor tool may be of the type manufactured, for example, by Glas-Weld Systems, Inc. (20578 Empire Blvd., Bend, Oreg. 97701), or by Makita (e.g., Makita model GV5000 disc sander, commonly available at hardware stores), or any number of manufacturers. Preferably, the abrasive pad rotates at between about 4000 and 6000 RPM (or, more preferably, at about 4500-4700 RPM). It has been observed that abrasive application pads supplied by Glas-Weld tend to provide best results. The application pads may be, for example, 4″ or 6″ in diameter (available from Glas-Weld Systems, Inc.). Ambient temperature for application should be about 50°-90° F. About a teaspoon amount of the glass restoration paste should be spread over the surface of the application pad, and water applied. The glass restoration paste and water may be mixed by hand over the surface of the application pad, and any excess glass restoration paste removed.

The glass surface should be wetted slightly, and the pad placed flush against the glass with the rotor tool off. The rotor tool should be turned on while keeping the pad flush against the glass surface and applying slight pressure. The rotor tool should be moved over small surface areas of the glass, rotating in a counterclockwise motion, for approximately 3-5 minutes per square foot of surface area. The actual time needed to remove the corrosion may vary depending on the extent of damage and operator efficiency and experience.

It is important to heat the glass from the friction of the rotor tool just enough that it is almost uncomfortable to the touch for annealed glass and slightly uncomfortable to the touch for tempered glass, but not hot. Overheating may burn the glass. For best results, small areas should be completed one at a time in approximately one square foot increments. The glass surface should be kept saturated with water while moving over the surface.

The surface should be rinsed and dried, and inspect for missed corrosion damage. The process should be repeated if needed to remove all corrosion damage.

Theoretical coverage rates of glass restoration paste are approximately 200 square feet per 14 oz. tub.

Pumice Polishing Cream

A cream that combines fine pumice with active cleaning agents may be used for removing oxidation and other deposits on metal, glass, fiberglass, marble, granite and paint surfaces. Normal rubbing methods with a wetted pad of cotton or a Fine 0000 steel wool can restore the surface in preparation for the siliceous surface sealant or the siliconized copolymer protective coating application. The pumice polishing cream returns the surface to its original state (but does not protect it). The repellent treatments (the siliceous surface sealant for glass, siliconized copolymer protective coating for almost all surfaces), discussed below should be applied as soon as possible to enhance and protect the newly restored surface.

The pumice polishing cream is a micro rubbing compound designed to remove sanding marks, paint defects and oxidation without the use of harsh abrasives. It prepares surfaces for waxing or glazing, restoring gloss, and leaving a clean finish. An example of a micro rubbing compound is available from Hi-Lustre Products, Inc., 3208 Fowler Street, Los Angeles, Calif. 90063, under product code #1060. To apply the micro rubbing compound, the compound should be shaken, and applied to a cool surface. The micro rubbing compound may be applied on a clean, soft cloth, and then rubbed onto a surface using light pressure to a desired finish. Excess should be wiped off with a clean, soft cloth. Alternatively, the micro-rubbing compound may be applied to a buffing pad on a rotor tool, and the surface buffed with light to medium pressure to desired finish. Excess should then be wiped off with a clean, soft cloth.

Water Spot Remover

A water spot remover in paste form may also be used for removing Stage II corrosion stains on glass. It can be applied using the same method as the application of the glass restoration paste. It can also be applied with a power-polishing pad, preferably taking care not to overheat the glass. The repellent treatment of the siliceous surface sealant plus the siliconized copolymer protective coating (discussed below) should generally be applied as soon as possible to enhance and protect the restored surface. If the glass was severely damaged, the siliceous surface sealant, the siliconized copolymer protective coating, and then cleaning the surface periodically with the regeneration cleaner (discussed below), preserves the restoration and prevents a rapid return of spotty deposits and further damage.

The water spot remover may be used to remove water spotting from glass, granite, tile, porcelain and metal surfaces. It is also applicable to shower doors, windows, windshields, fiberglass, chrome, tile and metal surfaces. An example of a water spot remover is one manufactured by Pacific Sun Makers, Inc. (671 El Camin Avenue, Sacramento, Calif. 95815) under the brand name A-MAZ Clean-Clear™. In one embodiment, the composition of the water spot remover is, e.g., as follows:

crystalline quartz silica, 60-70%;

naphtha, petroleum, heavy alkylate 5-10%;

9-octadecenoic acid, 5-10%;

triathanolamine, 5-10%.

One drop of the water spot remover will typically clean eight or nine square inches of the surface, and the water spot remover should not be overused. On clear glass, the water spot remover should preferably be applied with a soft cloth and spread very thinly. The water spot remover should then be rubbed briskly into the surface, and reapplied as necessary to ensure complete coverage.

Siliceous Surface Sealant

A siliceous surface sealant forms the basic reactive chemical treatment for glass and other siliceous surfaces, converting free oxygen from the OH groups near the surface to carbon, and creating a hydrophobic positively charged surface that repels water and dust. Exterior glass surfaces can be treated with the siliceous surface sealant to permanently link surface oxygen to carbon. The surface becomes chemically resistant to contaminants, preventing deterioration from repetitive moisture over time. Application of the siliceous surface sealant also prevents minerals from adhering to the surface, or being leached out from the surface, to form deposits on the surface. Thus, the siliceous surface sealant functions as surface sealer.

New or undamaged glass surfaces should be clean, dry and free from all contaminants prior to application of the siliceous surface sealant.

The siliceous surface sealant for glass, granite, porcelain and tile surfaces is usually applied as a wipe-on, vapor or spray. The siliceous surface sealant includes a dimethyldichlorosilane or dimethyldiethoxysilane

formulation that seals and protects the surface from water, dust, spills and environmental contaminants. The siliceous surface sealant chemically binds to the oxygen atoms in the surface structure of siliceous materials, making it highly repellent to contaminants that cause corrosion and staining. The siliceous surface sealant generally cures within a few seconds.

The siliceous surface sealant is formulated both as an interior (liquid form) and an exterior (vapor form) surface treatment, to seal and protect restored and new glass, granite, porcelain and tile surfaces. Both damage-restored and new surfaces are protected from corrosion and staining caused by water and other environmental contaminants, such as acid rain, salt fog, car emissions, etc. Since contaminants are repelled, maintenance is minimal and substantially simplified. As a glass sealant, the siliceous surface sealant keeps glass clean and clear. As a granite, porcelain and tile sealant, staining elements are repelled to keep the surface looking natural and new, without a need for corrosive cleaning chemicals.

One formulation of the siliceous surface sealant, which includes dimethyldichlorosilane (—C₂H₆Cl₂Si—), for use in exterior applications in vapor form, may be purchased from Gelest, Inc., 612 William Leigh Drive, Tullytown, Pa. 19007 (product ID SID4120.0). Another formulation of the siliceous surface sealant, which includes dimethyldiethoxysilane (—CH₃CH₂O)₂Si(CH₃)₂—), for use in interior applications (in liquid form) is available from, e.g., Genesee Polymers Corporation, G-5251 Fenton Rd., Flint, Mich. 48507, under product name EXP-49.

The surfaces should be clean, dry and free of stains and contaminants prior to application of the siliceous surface sealant. The siliceous surface sealant can be applied by wiping it onto the surface in liquid form, then rubbing off the slight haze with a micro-fiber cloth. The micro-fiber cloth is available from a number of suppliers, and is a blend of polyester and polyamide fibers, for example, 70% polyester and 30% polyamide.

Larger commercial applications can utilize the dimethyldichlorosilane in vapor form to cover large areas rapidly. Slight haze can be quickly removed with the micro-fiber cloth. While the siliceous surface sealant chemical reaction (i.e., replacement of oxygen with carbon in the siliceous surface) is permanent, exposure to harsh conditions can wear away the surface over time, reducing the hydrophobic properties of the surface.

Following proper surface preparation of the surface (i.e., removing any corrosion/damage, and cleaning the surface), the siliceous surface sealant may be applied by the following methods.

For all interior surfaces or exterior small surfaces, the siliceous surface sealant in liquid form should be poured into a narrow-mouth wash bottle with a squeeze drip nozzle. A generous amount of the siliceous surface sealant should be put on the surface, and then spread consistently and completely over the entire surface area, either by hand or using a PVA sponge. The surface should let stand for 30 to 60 seconds, then wiped off with a clean/cotton cloth. The surface should then be polished with the micro-fiber cloth.

The siliceous surface sealant exterior formulation should not generally be used in enclosed or dead-air areas, nor around unprotected humans and animals. The siliceous surface sealant should not be applied in direct sunlight and should be stored in a cool dry area suitable for flammable materials.

Ideal application temperature is approximately 60°- 90°F., more preferably 70°-80° F. The siliceous surface sealant dries to the touch usually in less than 45 seconds in air.

Theoretical coverage rate for the siliceous surface sealant is approximately 3,000 square feet per gallon for the interior formulation (dimethyldiethoxysilane) and approximately 9,000 square feet per gallon for the exterior formulation (dimethyldichlorosilane).

The siliceous surface sealant can also be applied in spray (suspension) form, to cover large areas.

Improper cleaners and airborne contaminants may degrade the siliceous surface sealant over time. To avoid degradation of the siliceous surface sealant, it is preferred that the siliconized copolymer protective coating, further discussed below, be applied to the surface after application of the siliceous surface sealant, with periodic cleaning using the regenerative cleaner, also discussed below.

In addition to siliceous surface sealant, other dimethyldichlorosilane or dimethyldiethoxysilane formulations can be used as surface sealants in various dilutions, depending upon the desired longevity of the product. See, e.g., U.S. Pat. No. 5,759,618 to Taylor et al., which discloses a number of dimethyldichlorosilane formulations, and which is incorporated by reference herein.

Stone Sealer

Optionally, after applying the siliceous surface sealant to a stone, porcelain and tile surfaces, a stone sealer may be used for additional protection. Stone sealers are available, for example, from Brightstone, Inc., 1636 West ₂₄₀th Street, Harbor City, Calif. 20710. The stone sealer includes a fluorinated co-polymer (less than 5%) and a hydrocarbon solvent (greater than 95%). The stone sealer has a theoretical coverage rate of 200 to 400 sq. ft. per gallon for porous stone, and 1,000 to 1,500 sq. ft. per gallon on polished stone. The stone sealer should be spread in an even and generous layer onto the stone surface using a clean brush, a lamb's wool applicator, a dense sponge, or a paint roller. On polished stone, it should be allowed to dry for one hour and then excess residue should be removed. The excess residue may be cleaned by buffing with a dry cloth. Unpolished or porous stone will typically soak up all the sealer and no further cleaning will be necessary. Extremely porous stone may require a second application after the first application has dried.

Siliconized Copolymer Protective Coating

A siliconized copolymer protective coating (such as an ethanol-based siliconized copolymer) may be applied by wiping it onto the surface with a wet pad, then rubbing off a slight haze with the micro-fiber cloth. The resulting surface is anti-static and dust repellent. Application of the siliconized copolymer protective coating after the siliceous surface sealant protects the surface, and enhances the sheen, and significantly extending repellent action and protection. Interior glass surfaces can be treated with the siliconized copolymer protective coating directly. The siliconized copolymer protective coating can be added to high maintenance areas or to all surfaces to optimize “stay-clean” appearance and minimize maintenance.

Prior to applying the siliconized copolymer protective coating, the surface should preferably be cleaned with a solution of about one part denatured alcohol and two parts water.

The siliconized copolymer protective coating is a field-applied coating for glass, metal, stone, fiberglass, paint, plastic and vinyl that reduces surface tension of the water drops on the surface to as low as 20 dynes/cm² from about 75 dynes/cm² for untreated surfaces. The siliconized copolymer protective coating is water repellent and functions as a sealant that keeps the surface clean and clear, so that aggressive cleaning chemicals are no longer needed.

In liquid form, the siliconized copolymer protective coating may be used as a surface treatment on glass and other non-porous surfaces. It may also be used as a surface treatment on metal surfaces, porcelain surfaces, fiberglass surfaces, non-vitreous tile surfaces, and plastic surfaces. It may also be used as a surface treatment on polished natural stone surfaces. The siliconized copolymer protective coating may also be used as a surface treatment on exterior building walls to protect against corrosion, a dust repellent chemical composition on exterior building walls to reduce the frequency of washing. The siliconized copolymer protective coating may also be used as a tarnish protective chemical composition for surface treatment on decorative fixtures in office buildings to protect against tarnishing. It may also be used as an anti-fouling chemical composition for surface treatment on boat hulls and boat super-structures. It may also be used as an anti-icing chemical composition for surface treatment on airplanes to prevent icing. It may also be used as a friction-reducing chemical composition for surface treatment to reduce friction. It may also be used as a surface treatment on airplanes to protect against corrosion. It may also be used as an appearance enhancing chemical composition on the surface of fleet vehicles to improve their appearance and reduce the frequency of washing. The siliconized copolymer protective coating seals and protects surfaces from corrosion, oxidization, staining and abrasion caused by water, dust, spills, environmental contaminants, acid rain, salt fog, car emissions and aggressive wear, without altering their appearance.

The siliconized copolymer protective coating, which is available from CTEK COATINGS LLC, 1820 South Grand Ave., Suite 0, Santa Ana, Calif. 92705, 888-749-8638, under the trademark BETA™, was previously available from S/P Resources, Inc., of Laguna Niguel, Calif. 92607 (949-362-8710), under the trademark ENVICOAT®. The siliconized copolymer protective coating is manufactured by Bell Additives, Inc., Bennett Dr., Longwood, Fla. (407) 339-2355 .

The siliconized copolymer protective coating generally cures within seconds. It has excellent adhesion, is UV resistant, is stable, does not yellow, chalk or flake, and provides protection for years. The siliconized copolymer protective coating also enhances surface resistance to abrasion from normal wear and vandalism. The siliconized copolymer protective coating may also be used to restore old surfaces to their near-new natural state. The siliconized copolymer protective coating may also be used to maintain new surfaces with a clean, natural look. Since contaminants and abrasion are repelled, maintenance is minimal and substantially simplified.

In a preferred embodiment, the siliconized copolymer protective coating is packaged, pre-mixed and is a single component that is applied without reduction or the use of additives. Theoretical coverage rates are approximately 1,000 square feet per gallon.

Following proper surface preparation with siliceous surface sealant, the siliconized copolymer protective coating is applied as follows:

For application to non-etched glass, the siliconized copolymer protective coating is poured into a bottle with a squeeze drip nozzle. A generous amount of the siliconized copolymer protective coating should be dripped on the surface and spread consistently and completely over the entire surface area using a PVA sponge. After 45 seconds or until substantially all the wetted sheen is gone, any residue of the siliconized copolymer protective coating should be wiped off with a clean, cotton cloth. The surface should then be polished with a micro-fiber cloth. The surface should be periodically cleaned after application with the regeneration cleaner.

As an alternative method of application, the siliconized copolymer protective coating can be sprayed from a spray bottle over the surface, converting the siliconized copolymer protective coating to a form of suspension that settles onto the surface, and then may be spread over the surface with the PVA sponge. This method of application may be particularly useful in covering large surface area.

For application to etched glass, the siliconized copolymer protective coating should be poured into a bottle with a squeeze drip nozzle. A small amount of the siliconized copolymer protective coating should be dripped on the surface and spread consistently and completely over the entire surface area using a PVA Sponge. The PVA sponge should be dampened with clean water, and immediately used to wipe the glass surface. The surface should be wiped again with a dry, clean cotton cloth, twice if needed. The surface should then be polished with a micro-fiber cloth.

Deeply etched surfaces may require more than two applications of the siliconized copolymer protective coating. It is preferred that the procedure be tested on a small area of the glass surface to determine how much product to apply and the number of times the process should be repeated to adequately coat the surface.

For application of the siliconized copolymer protective coating to granite, stone, fiberglass, vinyl, plastic and painted surfaces, it should be poured into a bottle with a squeeze drip nozzle. A generous amount of the siliconized copolymer protective coating should be dripped on the surface and spread consistently and completely over the entire surface area using a PVA sponge. The surface should stand for 45 seconds, and then any residue of the siliconized copolymer protective coating wiped off any with a clean, cotton cloth. The surface should be polished with a micro-fiber cloth. The surface should be periodically cleaned after application of the siliconized copolymer protective coating with a regenerative cleaner, discussed below.

In the preferred embodiment, the siliconized copolymer protective coating should be applied when ambient temperature is between 60 and 90° F., and preferably below 85° F.

It is believed that the siliconized copolymer protective coating could be diluted up to about 50% with alcohol or water (by volume) and still maintain its effectiveness.

The siliconized copolymer protective coating will last virtually indefinitely if maintained with the regeneration cleaner (discussed below), and there is no further need to use acidic or abrasive cleaners. However, the siliconized copolymer protective coating should be reapplied at the first indication that water repellency characteristics have degraded. For example, at five year intervals, exterior surfaces should be re-treated with the siliconized copolymer protective coating. The need and frequency of maintenance or re-coating with the siliconized copolymer protective coating will vary based on the severity of environmental conditions and the owner's desire regarding appearance.

As an alternative to the siliconized copolymer, coatings such as Rain-X® (—(CH₃)₂SiO—) (available from Unelko Corp., Scottsdale, Ariz.), CRL TPC Surface Protector (available from the CR Lawrence Co., Inc., 2503 E. Vernon Ave, Los Angeles, Calif. 90058, under Cat. No. TPC 16) (or other silicone-based polymers) may be applied to the surface, although it is believed that the siliconized copolymer sold under the BETA mark gives best results.

Paint Sealer

The siliconized copolymer protective coating may also be applied from a cream form, in order to seal and protect clear coat paint finishes from oxidation, damaging road substances, and ultraviolet radiation. One example of a starting material for the clear coat paint sealant is available from Hi-Lustre Products, Inc., 3208 Fowler Street, Los Angeles, Calif. 90063, under the product code # 1105. Hi-Lustre Products # 1105 is a combination of organic and organic synthetic polymers, monomers and waxes that includes 12-20% aliphatic hydrocarbons, and 2-8% calcine kaoline clay. Hi-Lustre Products # 1105 is then mixed with the siliconized copolymer protective coating (e.g. BETA™), resulting in a cream form of the siliconized co-polymer.

The resulting cream is preferably applied out of direct exposure to sunlight onto a cool surface. After applying a small amount of the clear coat paint sealer onto a terry cloth wax applicator, or a clean, soft cloth diaper, it should be rubbed onto a surface using light pressure. The compound should then be allowed to dry to a light haze and wiped off with a clean soft cloth diaper or towel. Alternatively, it may be applied with a rotor tool, using a polishing pad, and buffed to desired finish.

Regeneration Cleaner

A regeneration cleaner may be applied to glass, ceramics, tiles, porcelain, granite metals and plastics, to clean and protect by forming a hydrophobic coating, adding luster and repelling dust, finger printing and stains. Heavy stains such as grease, paints, cosmetics and dried foods are easily removed with the regeneration cleaner and buffed with the micro-fiber cloth. Subsequent dry-wiping or damp-wiping with the micro-fiber cloth cleans away stains. The siliconized copolymer protective coating and the regeneration cleaner may be applied to metals, plastics, paints, caulking, wood finishes, marble, granite and limestone. Periodic recharging with the regeneration cleaner maintains optimal appearance and extends life of the coating virtually indefinitely.

The regeneration cleaner may be used to restore water repellent properties for glass, stone, metal, paint, vinyl, plastics and fiberglass surfaces. The co-polymer molecules of the regeneration cleaner bind to the surface to protect it from contaminants re-attaching to the surface, protecting the surface from corrosion, oxidization, staining and abrasion. The regeneration cleaner maintains a new, natural appearance of the surface. The regeneration cleaner is generally most effective after the siliconized copolymer protective coating has been applied.

The regeneration cleaner cleans and protects both interior and exterior surfaces from corrosion, oxidation, staining and abrasion caused by water and other environmental contaminants, such as acid rain, salt fog, car emissions, etc. It enhances surface resistance to abrasion from normal wear and vandalism. Since contaminants and abrasion are repelled, maintenance is minimal and substantially simplified. The regeneration cleaner functions as a glass sealant, that keeps glass clean and clear. On all surfaces, degrading elements are repelled to keep the surface looking natural and new, essentially eliminating the need for aggressive cleaning chemicals.

The regeneration cleaner includes approximately 20% siliconized copolymer (e.g., BETA™) and 80% alcohol by volume. It is believed that the alcohol content could be reduced by 20% and replaced with water (i.e., to 64% alcohol, 20% siliconized copolymer, the remainder water), or the siliconized copolymer protective coating ratio could be increased as well.

The regeneration cleaner has a theoretical coverage rates of about 1,000 square feet per gallon. The regeneration cleaner should be applied when ambient temperature is between 50° and 90° F., and preferably when the ambient temperature is less than 85° F. The regeneration cleaner should generally not be used on lacquer finishes and some painted surfaces.

For general cleaning, the regeneration cleaner should be poured into a bottle with a spray nozzle. A generous amount of the regeneration cleaner should be sprayed or poured on the surface and spread consistently and completely over the entire surface area using a PVA sponge or a clean, cotton cloth. After about 20 seconds, the surface should be polished with a micro-fiber cloth. The regeneration cleaner typically dries within seconds.

Surfaces such as shower doors or public doors can be maintained with the regeneration cleaner. By applying the regeneration cleaner to a surface, a thin layer of the siliconized copolymer protective coating is formed, replenishing the repellent properties of the glass surface. A subsequent finishing with the micro-fiber cloth normally leaves no trace, no waxy glaze or cloudy haze associated with many other glass cleaners.

At each inspection, unusual spots should be cleaned with regeneration cleaner, wiping with the micro-fiber cloth. During periodic window cleaning, all glass exterior surfaces should preferably be cleaned with regeneration cleaner, using the micro-fiber cloth. Interior glass surfaces should be spot-cleaned with the regeneration cleaner using the micro-fiber cloth. Other treated interior glass surfaces can simply be wiped dry with micro-fiber cloth.

Possible Applications

The tables below illustrate some of the exemplary applications possible with various combinations of the products described above. It will be appreciated that the tables below are illustrative only, and the invention is not limited to these particular applications.

TABLE 1
APPLICATION METHODS

| | Glass | Granite | Paint | Metal |
|---|---|---|---|---|
| | Treatment | Restoration | Protection | Restoration |
| Prep. | Denatured | — | Water/ | — |
| Cleaning/ | Alcohol & | | Towel On & | |
| Applicator | Water/ | | Micro-fiber | |
| | Towel On & | | Cloth Off | |
| | Micro-fiber | | | |
| | Cloth Off | | | |
| Restoration/ | stain | pumice | pumice | pumice |
| Applicator | remover/ | polishing | polishing | polishing |
| | Rotor Tool | cream/ | cream/ | cream/ |
| | On & | Micro-fiber | Micro-fiber | Micro-fiber |
| | Rinse Off | Cloth or | Cloth | Cloth or |
| | | Fine Wool | | Fine Wool |
| Repellency/ | siliceous | siliconized | siliconized | siliconized |
| Applicator | surface | copolymer | copolymer | copolymer |
| | sealant/ | protective | protective | protective |
| | PVA Sponge | coating/ | coating/ | coating/ |
| | On & Micro- | PVA Sponge | PVA Sponge | Towel On & |
| | fiber | | | Micro-fiber |
| | Cloth Off | | | Cloth Off |
| Protection/ | the | paint | paint | the |
| Applicator | siliconized | sealer/ | sealer/ | siliconized |
| | copolymer | Towel On & | Towel On & | copolymer |
| | protective | Micro-fiber | Micro-fiber | protective |
| | coating/ | Cloth Off | Cloth Off | coating/ |
| | PVA Sponge | | | Towel On & |
| | On & Micro- | | | Micro-fiber |
| | fiber | | | Cloth Off |
| | Cloth Off | | | |
| Maintenance/ | the | the | the | the |
| Applicator | regeneration | regeneration | regeneration | regeneration |
| | cleaner/the | cleaner/the | cleaner/the | cleaner/the |
| | siliconized | siliconized | siliconized | siliconized |
| | copolymer | copolymer | copolymer | copolymer |
| | protective | protective | protective | protective |
| | coating, | coating | coating | coating |
| | Spray On & | Spray On & | Spray On & | Spray On & |
| | Micro-fiber | Micro-fiber | Micro-fiber | Micro-fiber |
| | Cloth Off | Cloth Off | Cloth Off | Cloth Off |

TABLE 2
EXEMPLARY APPLICABLE SURFACES

| | | | siliconized | | |
|---|---|---|---|---|---|
| | siliceous | siliceous | copolymer | | |
| | surface sealant | surface sealant | protective | regeneration | |
| | (liquid form) | (vapor) | coating | cleaner | paint sealer |
| Chemistry | Dimethyl- | Dimethyl- | Siliconized | Siliconized | Co-polymer, |
| | dichlorosilane/ | dichlorosilane | co-polymer | co-polymer with | alphatic |
| | dimethyl- | | | Alcohol and | hydrocarbons, |
| | diethoxy- | | | detergent | calcine kaoline |
| | silane | | | | clay |
| Application | 1. Squeeze | 1. Spray and | 1. Squeeze | 1. Spray and | 1. Wipe on, wipe |
| Methods | bottle and | blow | Bottle and | Hand Wipe | off |
| | Hand Wipe | | Hand Wipe | | |
| | 2. PVA | 2. Funnel | 2. PVA | | |
| | Sponge | Applicator | Sponge | | |
| | 3. Paint Cutter | | | | |
| Conditions | | | | | |
| Min. Temp | 60° F. | 61° F. | 60° F. | 60° F. | 60° F. |
| Max. Temp | 85° F. | 86° F. | 90° F. | 90° F. | 90° F. |
| Environmental | No direct sun | Exterior Use Only | | | |
| Substrates | | | | | |
| Glass: | | | | | |
| Clear | X | X | X | X | |
| Etched | X | X | X | X | |
| Metal | | X | X | X | |
| Porcelain | X | X | X | X | |
| Tile | X | X | X | X | |
| Fiberglass | | | X | X | X |
| Painted | | | X | X | X |
| Surfaces | | | | | |
| Vinyl | | | X | X | |
| Metals | | | | | |
| Brass | | | X | X | |
| Anodized | | | X | X | |
| Aluminum | | | | | |
| Stone: | | | | | |
| Granite | X | X | X | X | X |
| Marble | | | X | X | |
| Synthetic | | | X | X | |
| Marble | | | | | |
| Limestone | | | X | X | X |

It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A method of protecting and maintaining a surface of a siliceous material comprising:
cleaning said surface of said siliceous material;
restoring damaged portions of said surface of said siliceous material;
applying a reactive chemical solution to said surface of said siliceous material to cause a linking between carbon atoms in said reactive chemical solution to oxygen atoms in said siliceous material near said surface, thereby forming a continuous carbon chain to produce a hydrophobic surface having reduced surface tension;
applying a protective coating to said hydrophobic surface to infill porosity of said hydrophobic surface to preclude contamination and to further decrease surface tension; and
periodically cleaning said surface and re-applying said protective coating to maintain said surface.

2. The method of claim 1, wherein said restoring step comprises buffing said surface with a rotary wheel using a mildly abrasive restoration cream.

3. The method of claim 2, wherein said restoration cream comprises about 60% pumice and about 40% rare earth oxides.

4. The method of claim 2, further comprising the step of saturating said surface with water during the step of buffing said surface.

5. The method of claim 1, wherein said surface comprises any one of glass, porcelain, tile, stone, marble, travertine or granite.

6. The method of claim 1, wherein said reactive solution comprises dimethyldichlorosilane.

7. The method of claim 1, wherein said reactive solution comprises dimethyldiethoxysilane.

8. The method of claim 1, further including the step of removing excess reactive solution using a micro-fiber cloth prior to the step of applying said protective coating.

9. The method of claim 1, wherein said hydrophobic surface has a surface tension of less than about 25 dynes/cm² after the step of applying said protective coating.

10. The method of claim 1, further comprising the step of periodically applying a regenerative solution comprising about 15-40% of composition of said protective coating and the remaining 60-85% alcohol, to said hydrophobic surface to maintain water repellent properties of said surface.

11. The method of claim 1, wherein said protective coating is allowed to dry in ambient temperature between 60° and 90° F.

12. The method of claim 1, wherein said reactive solution is applied to said surface using a polyvinylalcohol sponge.

13. The method of claim 1, wherein the step of applying said protective coating to said surface first converts said protective coating to a suspension.

14. The method of claim 1, wherein the step of applying said protective coating to said surface occurs at ambient temperature of less than 85° F.

15. The method of claim 1, wherein the step of applying said reactive solution to said surface first converts said reactive solution to a vapor form.

16. The method of claim 1, wherein said protective coating comprises —(CH₃)₂SiO—.

17. The method of claim 1, wherein said protective coating TM comprises BETA ™.

18. A method of protecting and maintaining a surface of a siliceous material comprising:
restoring damaged portions of said surface of said siliceous material;
cleaning said surface of said siliceous material;
sealing said surface of said siliceous material;
applying a protective coating to said surface of said siliceous material; and
periodically applying a rejuvenating cleaner to said surface of said siliceous material.

19. The method of claim 18, wherein said surface comprises any one of glass, porcelain, tile, marble, stone, travertine or granite.

20. The method of claim 18, wherein said sealing step uses dimethyldichlorosilane.

21. The method of claim 18, wherein said sealing step uses dimethyldiethoxysilane.

22. The method of claim 18, wherein said sealing step further comprises the step of removing excess reactive solution using a micro-fiber cloth prior to the step of applying the protective coating.

23. The method of claim 18, wherein the rejuvenating cleaner comprises about 15-40% siliconized co-polymer and the remaining 60-85% alcohol to said surface to maintain water repellent properties of said surface.

24. The method of claim 18, wherein said protective coating is allowed to dry in ambient temperature between 60° and 90° F.

25. The method of claim 18, wherein the step of applying said siliconized co-polymer protective coating to said surface occurs at ambient temperature of less than 85° F.

26. The method of claim 18, wherein said restoring step comprises the step of buffing said surface with a rotary wheel using a mildly abrasive restoration cream.

27. The method of claim 26, wherein said restoration cream comprises about 60% pumice and about 40% rare earth oxides.

28. The method of claim 26, further comprising the step of saturating said surface with water during the step of buffing said surface.

29. The method of claim 18, wherein said protective coating comprises one of —(CH₃)₂SiO— and CRL TPC Surface Protector.

30. The method of claim 18, wherein said protective coating comprises BETA™.

31. The method of claim 18, wherein said rejuvenating cleaner comprises BETA™.

32. A method of protecting and maintaining a surface of a siliceous material comprising:
applying a reactive solution to a clean surface of said siliceous material to link carbon atoms in said reactive solution to oxygen atoms in said siliceous material near said surface, thereby forming a hydrophobic surface having reduced surface tension;
applying a siliconized co-polymer protective coating to said hydrophobic surface to infill porosity of said hydrophobic surface to preclude contamination and to further decrease surface tension; and
periodically cleaning said surface and re-applying a mixture of said protective coating and alcohol to maintain hydrophobic properties of said surface.

33. The method of claim 32, wherein said reactive solution comprises dimethyldichlorosilane.

34. The method of claim 32, wherein said reactive solution comprises dimethyldiethoxysilane.

35. The method of claim 32, wherein the step of applying said siliconized co-polymer protective coating to said surface occurs at ambient temperature of less than 85° F.

36. The method of claim 32, further comprising the step of restoring damaged portions of said surface of said siliceous material.

37. The method of claim 36, wherein said restoring step comprises the step of buffing said surface with a rotary wheel at approximately 4600 RPM while applying a mildly abrasive restoration cream to said surface with a felt pad.

38. The method of claim 37, wherein said restoration cream comprises about 60% pumice and about 40% rare earth oxides.

39. The method of claim 32, wherein said protective coating comprises about 80% ethanol-based siliconized copolymer suspended in about 20% isoproponol.

40. A method of protecting a surface comprising:
applying a reactive solution to said surface to link carbon atoms in said reactive solution to oxygen atoms near said surface, thereby forming a hydrophobic surface having reduced surface tension; and
applying a siliconized co-polymer protective coating to said hydrophobic surface.

41. The method of claim 40, wherein said surface has a surface tension of less than 25 dynes/cm² after the step of applying said siliconized co-polymer protective coating.

42. The method of claim 40, further comprising the step of periodically applying a regenerative solution of about 15-40% siliconized co-polymer protective coating and the remaining 60-85% alcohol to the hydrophobic surface to maintain water repellent properties of said surface.

43. The method of claim 40, wherein the step of applying said siliconized co-polymer protective coating to said surface occurs at ambient temperature of less than 85° F.

44. A method of protecting a surface comprising:
applying a reactive solution to said surface to link carbon atoms in said reactive solution to oxygen atoms near said surface, thereby forming a hydrophobic surface having reduced surface tension; and
applying a regenerative solution of about 15-40% siliconized copolymer and 60-85% alcohol to the hydrophobic surface.

45. The method of claim 44, wherein said siliconized copolymer protective coating comprises BETA™.

46. A method of protecting a surface comprising:
cleaning a surface of any corrosion and damage, said surface being selected from any one of porcelain, tile, marble, stone, travertine, metal, vinyl, paint, etched glass or granite; and
applying a siliconized co-polymer protective coating to said surface.

47. A method of protecting a surface comprising:
cleaning a surface of any corrosion and damage;
applying a reactive solution to said surface to link carbon atoms in said reactive solution to oxygen atoms near said surface, thereby forming a hydrophobic surface having reduced surface tension; and
wiping off excess reactive solution from said surface with a microfiber cloth.

48. A glass restoration paste comprising:
about 60% fine silicon dioxide pumice; and
about 40% rare earth oxide.

49. The glass restoration paste of claim 48, wherein said fine silicon dioxide pumice is a 700 grit pumice.

50. The glass restoration paste of claim 48, wherein said rare earth oxide comprises lanthanum oxide.

51. The glass restoration paste of claim 48, wherein said rare earth oxide comprises cerium oxide.

52. A kit for protecting and maintaining a surface of a siliceous material comprising:
a reactive chemical solution that causes a linking between carbon atoms in said reactive chemical solution to oxygen atoms in said siliceous material near said surface;
a siliconized copolymer protective coating; and
a rejuvenating cleaner.

53. A kit for protecting and maintaining a surface of a siliceous material comprising:
a siliconized copolymer protective coating in liquid form; and
a rejuvenating cleaner comprising about 15-40% siliconized copolymer and about 60-85% alcohol.

54. The kit of claim 53, further comprising the siliconized copolymer in paste form.

55. A rejuvenating cleaner comprising:
about 15-40% ethanol-based siliconized copolymer; and
about 60-85% alcohol.

56. A method of protecting a surface comprising:
applying an ethanol-based siliconized copolymer to the surface; and
periodically applying a regenerative solution of about 15-40% ethanol-based siliconized copolymer and 60-85% alcohol to the surface.

57. The method of claim 56, further comprising the step of applying the ethanol-based siliconized copolymer in paste form to the surface.

58. A method of protecting a surface comprising:
applying a regenerative solution of about 15-40% ethanol-based siliconized copolymer and 60-85% alcohol to the surface; and
applying the ethanol-based siliconized copolymer in paste form to the surface.
